(19) United States
(12) Patent Application Publication
(10) Pub. No.: US 2025/0237334 A1
(43) Pub. Date: Jul. 24, 2025

(54) COUPLING STRUCTURE AND GROMMET

(71) Applicants: TOYOTA JIDOSHA KABUSHIKI KAISHA, Toyota-shi (JP); YAZAKI CORPORATION, Tokyo (JP)

(72) Inventors: Ryosuke OHFUKU, Toyota-shi (JP); Yoshimichi YAMAO, Toyota-shi (JP)

(73) Assignees: TOYOTA JIDOSHA KABUSHIKI KAISHA, Toyota-shi (JP); YAZAKI CORPORATION, Tokyo (JP)

(21) Appl. No.: 19/033,230

(22) Filed: Jan. 21, 2025

(30) Foreign Application Priority Data
Jan. 24, 2024 (JP) 2024-008982

(51) Int. Cl. F16L 25/00

(52) U.S. Cl. CPC F16L 25/0054

(57) ABSTRACT

A coupling structure includes: a grommet having a tubular part; and a corrugated tube that is to be inserted into the tubular part. The corrugated tube alternately has a crest part and a trough part. The tubular part has a plurality of projection parts each provided to protrude to be annular on an inner circumferential surface, and an annular recess part provided on the inner circumferential surface and alternately disposed with the projection part. The projection part is provided so as to have a larger pitch than the trough part.

### CROSS-REFERENCE TO RELATED APPLICATION

This application claims priority to Japanese Patent Application No. 2024-008982 filed on Jan. 24, 2024, incorporated herein by reference in its entirety.

### BACKGROUND

### 1. Technical Field

The present disclosure relates to a technology of coupling a corrugated tube to a tubular part of a grommet.

### 2. Description of Related Art

Japanese Unexamined Patent Application Publication No. 2017-225339 discloses a grommet that is to be put on a corrugated tube. The grommet includes: a tubular corrugated tube-side end part that can be connected onto the outer circumferential side of the corrugated tube in the sealed state; and a plurality of sealing lips provided into ridges so as to be in close contact with trough parts of the corrugated tube on the inner circumferential surface of the corrugated tube-side end part.

### SUMMARY

With the technology disclosed in JP 2017-225339 A, the sealing lip of the grommet is to enter the trough part of the corrugated tube, which each time causes the sealing lip to get over the crest part of the corrugated tube, and it is desired to improve insertion ability.

An object of the present disclosure is to provide a technology to improve insertion ability of a corrugated tube into a tubular part of a grommet.

In order to solve the aforementioned problem, there is provided a coupling structure according to an aspect of the present disclosure, including: a grommet having a tubular part; and a corrugated tube that is to be inserted into the tubular part. The corrugated tube alternately has a crest part and a trough part. The tubular part has a plurality of projection parts each provided to protrude to be annular on an inner circumferential surface, and an annular recess part provided on the inner circumferential surface and alternately disposed with the projection part. The projection part is provided so as to have a larger pitch than the trough part.

There is provided a grommet according to another aspect of the present disclosure which grommet is to be coupled to a corrugated tube. The grommet includes a tubular part that the corrugated tube is to be inserted into. The tubular part has a plurality of projection parts each provided to protrude to be annular on an inner circumferential surface, and an annular recess part provided on the inner circumferential surface and alternately disposed with the projection part. The projection part is provided so as to have a larger pitch than a trough part of the corrugated tube.

According to the present disclosure, there can be provided a technology to improve insertion ability of a corrugated tube into a tubular part of a grommet.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a coupling structure of an embodiment;

FIG. 2 is a sectional view of the coupling structure of the embodiment;

FIG. 3 is a sectional view having a coupling portion of a grommet and a corrugated tube expanded;

FIG. 4A is a view for explaining actions at the time when the grommet and the corrugated tube are coupled;

FIG. 4B is a view for explaining the actions at the time when the grommet and the corrugated tube are coupled;

FIG. 4C is a view for explaining the actions at the time when the grommet and the corrugated tube are coupled; and

FIG. 4D is a view for explaining the actions at the time when the grommet and the corrugated tube are coupled.

### DETAILED DESCRIPTION OF EMBODIMENTS

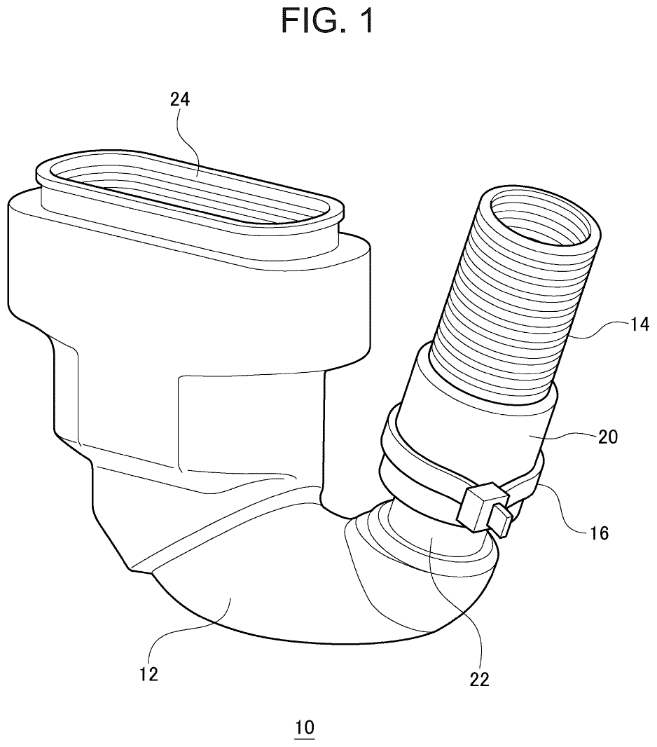

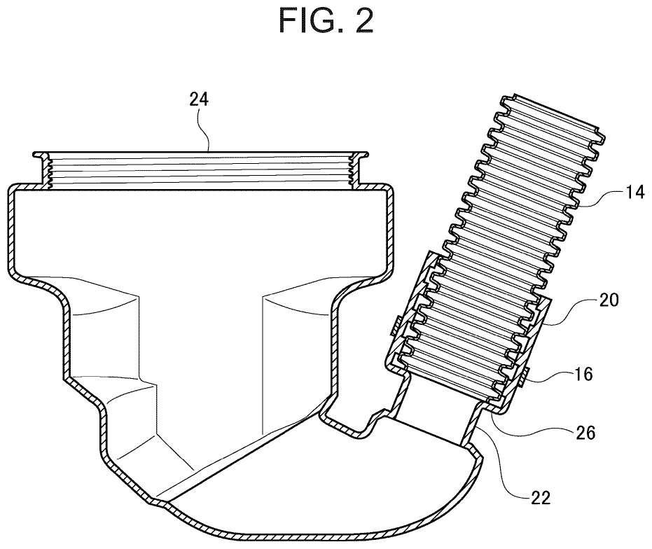

FIG. 1 is a perspective view of a coupling structure 10 of an embodiment. Moreover, FIG. 2 is a sectional view of the coupling structure 10 of the embodiment. The coupling structure 10 includes a grommet 12, a corrugated tube 14, and a band 16. The coupling structure 10 has a penetrating space inside and is used for circumferentially enclosing wiring members such as a harness and a wire and protecting the wiring members. Coupling of the grommet 12 and the corrugated tube 14 is sealed such that water does not enter the inside of the coupling structure 10.

The grommet 12 is formed of a resin material and is to be coupled to the corrugated tube 14. The grommet 12 has a tubular part 20, a small tube part 22, a connection part 24, and a step part 26. The tubular part 20 is positioned and opens at one end of the grommet 12, and the connection part 24 is positioned and opens at the other end of the grommet 12.

Into the tubular part 20, the corrugated tube 14 is inserted from an opening 20a. The small tube part 22 is formed to have a smaller diameter than the tubular part 20. The step part 26 is a portion connecting the tubular part 20 and the small tube part 22. The step part 26 is formed to be annular such that a diameter of the step part 26 decreases from the tubular part 20 to the small tube part 22. The step part 26 forms a step surface extending in directions intersecting the axial direction.

The connection part 24 is formed into a long hole shape. The connection part 24 has an annular seal lip on the inner circumferential surface. The connection part 24 is to be connected to another member. While the grommet 12 is formed to be curved between the tubular part 20 and the connection part 24, not being limited to this aspect, the grommet 12 may have another shape as long as the grommet 12 has a hollow shape and the sealability is secured.

The corrugated tube 14 is inserted into the tubular part 20. The band 16 is wound on the outer circumference of the tubular part 20 and is fastened inward in the radial direction from the outer side of the tubular part 20. The fastening of the band 16 fixes the corrugated tube 14 to the tubular part 20.

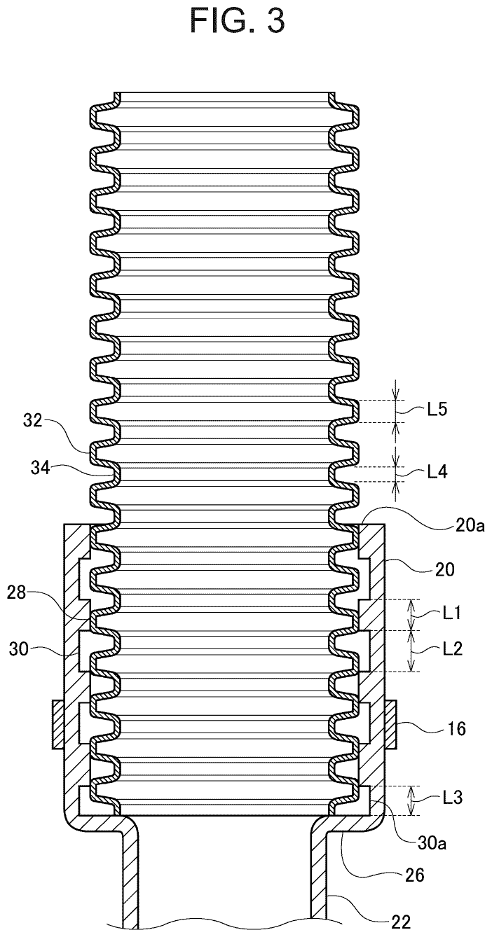

FIG. 3 is a sectional view having the coupling portion of the grommet 12 and the corrugated tube 14 expanded. The tubular part 20 has a plurality of projection parts 28 and a plurality of recess parts 30. The projection parts 28 are formed to protrude on the inner circumferential surface of the tubular part 20, being formed to be annular. The recess parts 30 are formed to be recessed on the inner circumferential surface of the tubular part 20, being formed to be annular. The projection parts 28 and the recess parts 30 are alternately arranged side by side.

A protruding end of the projection part 28 is formed to be planar and comes into contact with a crest part 32. The projection part 28 is arranged at a position of the opening end of the tubular part 20, and the recess part 30 is arranged at a position adjacent to the step part 26 on the innermost side.

The corrugated tube 14 has a plurality of crest parts 32 and a plurality of trough parts 34. The crest parts 32 are formed to protrude into annular shapes, and the trough parts 34 are formed to be recessed into annular shapes. The crest parts 32 and the trough parts 34 are alternately arranged. A protruding end of the crest part 32 is formed to be planar, and lateral surfaces of the crest part 32 are inclined so as to be tapered toward the protruding end.

A pitch L1 of the projection part 28 is formed to be larger than a pitch L4 of the trough part 34. Thereby, the projection part 28 can be configured not to enter the trough part 34. Therefore, when the corrugated tube 14 is inserted into the tubular part 20, the projection part 28 can be restrained from entering the trough part 34 and stopping the insertion of the corrugated tube 14. Moreover, molding can be made easier since the pitches of the projections and the recesses on the inner circumferential surface of the tubular part 20 can be made larger than in the case where the pitch of the recess part 30 is made smaller than the pitch of the crest part 32. The pitch L1 of the projection part 28 is a length of a planar portion of the protruding end of the projection part 28. Moreover, the pitch L4 of the trough part 34 corresponds to the largest portion of the inclined trough part 34 on the radial directional outer side.

A pitch L2 of the recess part 30 may be a measurement not less than the pitch L1 of the projection part 28. By making the pitch L2 of the recess part 30 large, the tubular part 20 can be configured to be flexible.

A height by which the projection part 28 protrudes inward in the radial direction is smaller than a height by which the crest part 32 protrudes outward in the radial direction. Thereby, a thickness of the tubular part 20 can be restrained.

A pitch L3 of a recess part 30a adjacent to the step part 26 may be formed to be larger than a pitch L5 of the crest part 32. The innermost recess part 30a is formed such that the crest part 32 can enter the recess part 30a.

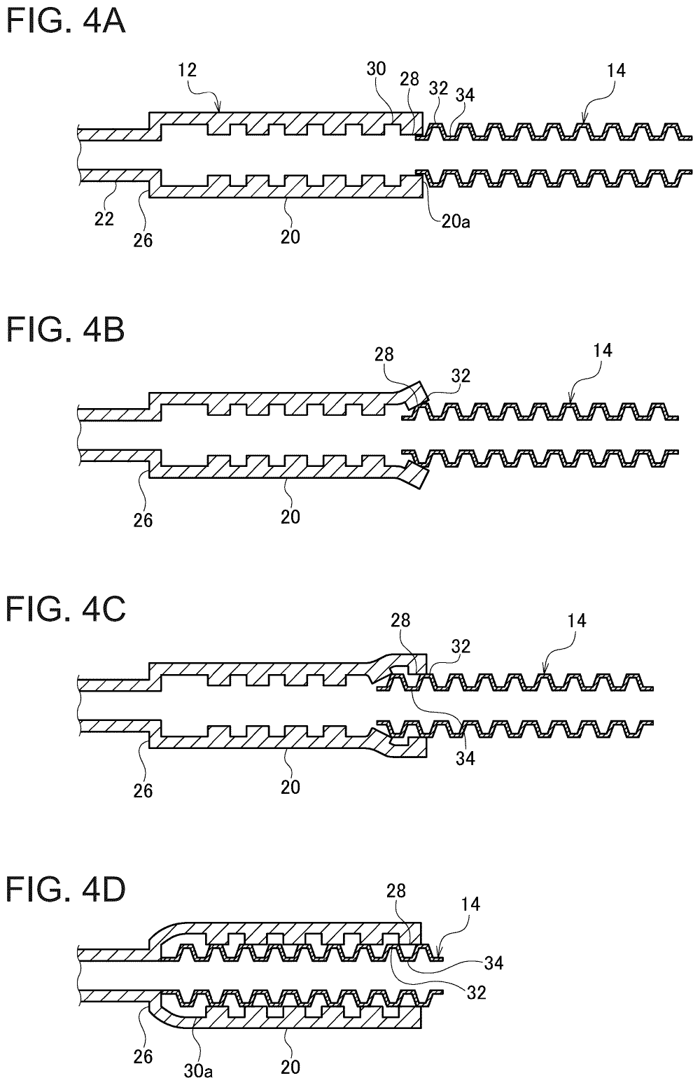

FIG. 4A, FIG. 4B, FIG. 4C, and FIG. 4D are views for explaining actions at the time when the grommet 12 and the corrugated tube 14 are coupled.

FIG. 4A shows a state where one end of the corrugated tube 14 starts to be inserted from the opening 20a of the tubular part 20 and comes into contact with the edge of the opening 20a. On the tubular part 20 in a free state before the corrugated tube 14 being inserted, an inner diameter of the projection part 28 is smaller than an outer diameter of the crest part 32. Therefore, in insertion of the corrugated tube 14, the crest part 32 comes into contact with the projection part 28 of the tubular part 20.

FIG. 4B shows a situation where the projection part 28 comes into contact with the crest part 32 to enlarge the diameter. The tubular part 20 is formed of a softer material than the corrugated tube 14, is formed to be more flexible than the corrugated tube 14, and is stretched and widened to enlarge the diameter by the projection part 28 coming into contact with the crest part 32.

FIG. 4C shows a situation where the corrugated tube 14 is further inserted into the tubular part 20 and the tubular part 20 gradually enlarges the diameter from the opening 20a side. As the crest part 32 is entering the tubular part 20, the tubular part 20 is enlarging the diameter. Since the pitch L1 of the projection part 28 is larger than the pitch L4 of the trough part 34, the projection part 28 does not enter the trough part 34 or fit into the trough part 34. Therefore, without the projection part 28 fitting into the trough part 34, the corrugated tube 14 can be inserted while enlarging the diameter of the tubular part 20. The insertion of the corrugated tube 14 does not stop due to the projection part 28 fitting into the 25 trough part 34 in the middle of the insertion.

FIG. 4D shows a state where the corrugated tube 14 is further inserted into the tubular part 20 and the one end of the corrugated tube 14 comes into contact with the step part 26. The step part 26 functions as a stopper for the corrugated tube 14 when the corrugated tube 14 is inserted into the tubular part 20. By the corrugated tube 14 coming into contact with the step part 26, an operator can recognize the completion of the insertion of the corrugated tube 14.

The insertion of the corrugated tube 14 makes the state where the tubular part 20 enlarges the diameter. In the state where the insertion of the corrugated tube 14 is completed, the tubular part 20 enlarges the diameter such that the inner diameter of the projection part 28 is equal to the outer diameter of the crest part 32. The innermost recess part 30a is curved so as to shrink the diameter toward the step part 26. The crest part 32 enters the recess part 30a. By the band 16 fastening the outer circumference of the tubular part 20, the corrugated tube 14 is fixed to the tubular part 20. Thereby, coupling work of the corrugated tube 14 is completed. By the projection parts 28 being elastically in contact with the crest parts 32, sealability of the grommet 12 and the corrugated tube 14 can be secured.

As above, the present disclosure has been described based on the embodiment. The present disclosure is not limited to the aforementioned embodiment and can also be modified with various design changes and the like based on the knowledge of the skilled in the art.

What is claimed is:

1. A coupling structure comprising:
a grommet having a tubular part; and
a corrugated tube that is to be inserted into the tubular part, wherein:
the corrugated tube alternately has a crest part and a trough part;
the tubular part has
a plurality of projection parts each provided to protrude to be annular on an inner circumferential surface, and
an annular recess part provided on the inner circumferential surface and alternately disposed with the projection part; and
the projection part is provided so as to have a larger pitch than the trough part.

2. The coupling structure according to claim 1, wherein the tubular part is provided to be more flexible than the corrugated tube, and enlarges a diameter by the crest part coming into contact with the projection part.

3. The coupling structure according to claim 1, wherein the grommet has a small tube part provided to have a smaller diameter than the tubular part, and an annular step part provided from the tubular part to the small tube part.

4. The coupling structure according to claim 3, wherein the step part functions as a stopper for the corrugated tube when the corrugated tube is inserted into the tubular part.

5. A grommet that is to be coupled to a corrugated tube, the grommet comprising a tubular part that the corrugated tube is to be inserted into, wherein:
the tubular part has
a plurality of projection parts each provided to protrude to be annular on an inner circumferential surface, and
an annular recess part provided on the inner circumferential surface and alternately disposed with the projection part; and
the projection part is provided so as to have a larger pitch than a trough part of the corrugated tube.
